(19) United States
(12) Patent Application Publication
(10) Pub. No.: US 2014/0154504 A1
(43) Pub. Date: Jun. 5, 2014

(54) FUNCTIONAL FILM

(71) Applicant: Hitoshi Adachi, Atsugi-shi (JP)

(72) Inventor: Hitoshi Adachi, Atsugi-shi (JP)

(73) Assignee: Konic Minolta, Inc., Tokyo (JP)

(21) Appl. No.: 14/234,175

(22) PCT Filed: Jul. 11, 2012
(86) PCT No.: PCT/JP2012/067720

§ 371 Date: Jan. 22, 2014

(30) Foreign Application Priority Data
Aug. 2, 2011 (JP) 2011-169063

(51) Int. Cl. B32B 27/28; C08L 83/04

(52) U.S. Cl. CPC B32B 27/283; C08L 83/04
USPC 428/339; 428/447; 524/588

(57) ABSTRACT

A functional film includes a resin substrate and an outermost layer containing a material having a metalloxane skeleton. The outermost layer contains an ultraviolet absorber. A surface of the functional film has a contact angle with water of 80° or more and less than 170° and a coefficient of dynamical friction of 0.10 or more and 0.35 or less.

### TECHNICAL FIELD

The present invention relates to a functional film having high fouling, scratch, and weather resistances and capable of being produced at high productivity.

### BACKGROUND ART

Functional films are applied to various fields. For example, functional films are attached, for example, as heat barrier films, antifouling films, and protective films to the outermost surfaces of articles and are required to have various types of high added values. Recent requirements for the functional films attached to the outermost surfaces are, for example, improvements in fouling resistance, scratch resistance and weather resistance.

Resins are usually used as substrates of films. The use of resins as the substrates of films readily causes electrostatic charge, exacerbating the risk of soiling, i.e., ready attachment of foulings such as dust. Since the substrates used are mainly composed of soft resins, the films are readily damaged. Thus, the resins also have a disadvantage of low scratch resistance. In addition, resins are readily deteriorated by exposure to ultraviolet rays or heat for long times and thereby also have a disadvantage of low weather resistance.

An example of a functional film is a transparent heat barrier film having surface protective layer of photoradically curable urethane acrylate, which are described in Patent Literature 1.

### CITATION LIST

### Patent Literature

[Patent Literature 1] Japanese Unexamined Patent Application Publication No. 2006-264167

### SUMMARY OF INVENTION

### Problem to be Solved by the Invention

Unfortunately, the surface protective layer composed of photoradically curable urethane acrylate described in Patent Literature 1 exhibits still insufficient scratch, weather, and fouling resistances.

An object of the present invention, which has been accomplished in view of the above-mentioned problems, is to provide a functional film exhibiting high scratch, weather, and fouling resistances even when it is disposed on the outermost surface of an article. Another object of the present invention is to provide a functional film capable of being produced at high productivity.

### Means to Solve the Problem

The objects of the present invention can be achieved by the following aspects.

The functional film according to Aspect 1 is a functional film including a resin substrate and an outermost layer containing a material having a metalloxane skeleton, in which the outermost layer contains an ultraviolet absorber, and a surface of the functional film has a contact angle with water of 80° or more and less than 170° and a coefficient of dynamical friction of 0.10 or more and 0.35 or less.

Since the outermost layer contains a material having a metalloxane skeleton, the functional film can have high scratch resistance and weather resistance more than ever.

The present inventor has found that sticky soiling that is barely removable occurs on the surface of a film through adhesion of water droplets containing pollutants onto the film surface and subsequent evaporation of the water. That is, the inventor has found that water droplets remaining on the surface of a film for a long time are one of the major causes of soiling. From this viewpoint, water droplets can be prevented from remaining on the surface of a functional film by controlling the contact angle of water of the film surface to 80° or more and less than 170°. Such a measure can significantly improve the fouling resistance.

The present inventor has further found that the coefficient of dynamical friction of the surface of a film is also an important factor for the productivity and scratch resistance of the film. A coefficient of dynamical friction of higher than 0.35 cannot substantially improve the scratch resistance, whereas a coefficient of dynamical friction of less than 0.10 provides excessively high slippage to the surface, leading to occurrence of, for example, winding deviation during a production process. A coefficient of dynamical friction of 0.10 or more and 0.35 or less can simultaneously lead to high productivity and high scratch resistance. Furthermore, the functional film having a surface layer containing an ultraviolet absorber can have high weather resistance and can be applied to the surface of an article.

According to Aspect 2, the outermost layer of the functional film according to Aspect 1 has a pencil hardness of H or more and 7H or less.

According to Aspect 3, the functional film according to Aspect 1 or 2 has a coefficient of dynamical friction of 0.15 or more and 0.30 or less.

According to Aspect 4, the functional film according to any one of Aspects 1 to 3 has a surface having a surface resistivity of 1×10¹³Ω/□ or less.

Films including resin substrates can readily be charged to cause adhesion of dust onto their surfaces. A surface having a surface resistivity within the above-mentioned range can inhibit the adhesion of dust and can improve the fouling resistance. In particular, in outdoor use of a heat barrier film including a silver layer, silver is deteriorated by external factors such as sulfides (and desert dust). A surface resistivity within the above-mentioned range inhibits adhesion of dust onto the surface, resulting in prevention of contact of sulfides to silver. Consequently, the silver layer can be protected from deterioration, resulting in improved weather resistance.

According to Aspect 5, the outermost layer of the functional film according to any one of Aspects 1 to 4 is formed through a thermal curing reaction using a sol-gel method.

According to Aspect 6, the material having a metalloxane skeleton according to any one of Aspects 1 to 5 is polysiloxane.

Polysiloxane alleviates the blocking phenomenon when a functional film is wound during the production process of the film by a roll-to-roll system, provides stiffness to the surface film layer, and inhibits occurrence of stretching distortion of the film during conveyance in a wound state. Thus, the polysiloxane maintains the functions required for the functional film even in a wound state and can further improve the fouling resistance of the film.

According to Aspect 7, the functional film according to any one of Aspects 1 to 6 further includes an antistatic layer between the outermost layer and the resin substrate.

Films including resin substrates are readily charged to cause adhesion of dust onto their surfaces. An antistatic layer provided between the outermost layer and the resin substrate can inhibit the adhesion of dust and can thus improve the fouling resistance. In particular, in outdoor use of a heat barrier film including a silver layer, silver is deteriorated by external factors such as sulfides (and desert dust). An antistatic layer provided between the outermost layer and the resin substrate inhibits adhesion of dust onto the surface of the film, resulting in prevention of contact of sulfides to silver. Consequently, the silver layer can be protected from deterioration, resulting in improved weather resistance.

According to Aspect 8, the ultraviolet absorber in the functional film according to any one of Aspects 1 to 7 is an inorganic ultraviolet absorber.

When the ultraviolet absorber is an inorganic ultraviolet absorber, the ultraviolet absorber barely bleeds out from the outermost layer, resulting in improved weather resistance.

According to Aspect 9, the functional film according to any one of Aspects 1 to 8 further includes a silver layer having a thickness of 0.1 nm or more and 50 nm or less.

According to Aspect 10, the functional film according to Aspect 9 is a heat barrier film.

The functional film may be a heat barrier film including a silver layer.

From the viewpoint of efficient thermal insulation, the heat barrier film is desirably disposed on the outdoor side rather than the indoor side of a glass window. The heat barrier film disposed on the outdoor side is, however, exposed to sunlight containing ultraviolet rays and weathered for a long time, and is soiled with dust and sand adhering thereon. In particular, in heat barrier films including resin substrates, weather, scratch, and fouling resistances are further important factors. Since the present invention can achieve high weather, scratch, and fouling resistances, the heat barrier film will maintain the properties for a long time even if the film is disposed on the outdoor side of a glass window.

According to Aspect 11, in the functional film according to Aspect 9 or 10, a layer adjoining the silver layer contains a silver corrosion inhibitor.

If the silver layer is corroded, for example, the thermal insulation decreases. In particular, the silver layer usually has a low thickness, such as 50 nm or less, and is highly affected by corrosion compared to silver reflection layers such as mirrors that reflect visible light. If the layer adjoining the silver layer contains a corrosion inhibitor, the silver layer is protected from corrosion, and the characteristics, such as thermal insulation, of the functional film can be maintained for a long time.

### Advantageous Effects of Invention

The present invention can provide a functional film having high scratch, weather, and fouling resistances and also capable of being produced at high productivity.

### DESCRIPTION OF EMBODIMENTS

The present invention, its components, and embodiments of the present invention will now be described in detail.

Examples of the functional film of the present invention include heat barrier films, antifouling films, and protective films. The functional film may be a film mirror reflecting sunlight.

The major object of the present invention is to improve the scratch, weather, and fouling resistances of the functional film. From such a viewpoint, the advantageous effects are noticeably shown when the functional film is disposed on the outermost surface of an article or when the functional film is used outdoors. In particular, the advantageous effects of the present invention are outstanding when the functional film is used as a heat barrier film disposed on the outdoor side.

The functional film of the present invention includes an outermost layer and a resin substrate. The film may further include any layer in addition to the resin substrate and the outermost layer.

The surface of the functional film has a contact angle with water of 80° or more and less than 170° and preferably 90° or more and 150° or less.

The contact angle with water can be measured with a contact angle gauge CA-W manufactured by Kyowa Interface Science Co., Ltd. at 23° C. and 55% RH by dropping 3 μL of water onto the surface of a functional film.

The surface of the functional film has a coefficient of dynamical friction of 0.10 or more and 0.35 or less and preferably within a range of 0.15 or more and 0.30 or less.

The coefficient of dynamical friction can be measured with a surface property tester (HEIDON-14D) manufactured by Shinto Scientific Co., Ltd. by attaching a sheet of a functional film to a sample table such that the outermost layer is at the top, attaching another sheet of the functional film to a penetrator, overlapping the two sheets of the functional film such that the outermost surfaces thereof are in contact with each other, and reciprocatively moving a load of about 160 g/cm² on the films at a rate of 3 m/min at ten times. The coefficient of dynamical friction can be calculated as the average coefficient of dynamical friction of ten cycles of the reciprocating motions.

The surface of the functional film preferably has a pencil hardness of H or more and 7H or less, and the number of scratches after a steel wool test under a load of 500 g/cm² preferably does not exceed 30.

Furthermore, the surface of the functional film preferably has a surface resistivity of 1×10¹³Ω/□ or less, more preferably 1.0×10⁻³Ω/□ or more and 1.0×10¹²Ω/□ or less, and most preferably 3.0×10⁹Ω/□ or more and 2.0×10¹¹Ω/□ or less.

In production of the functional film, a roll-to-roll system is preferably used. From the viewpoint of preventing adhesion of a film, such as blocking, during the production process, the surface roughness Ra is preferably 0.01 μm or more, and is preferably 0.1 μm or less for inhibiting, for example, light scattering. Although a slightly roughened surface readily causes adhesion of dust and other materials onto the functional film surface, the adhesion of dust can be inhibited by disposing an antistatic layer and/or restricting the surface resistivity of the functional film surface to 1×10¹³Ω/□ or less.

The total thickness of the functional film is preferably 10 to 500 μm, more preferably 30 to 300 μm, and most preferably 50 to 200 μm, from the viewpoints of deflection prevention, regular reflectance, workability, and other factors.

### 1. Outermost Layer

The outermost layer is a layer disposed on the outermost surface of a functional film. The outermost layer preferably defines the outermost surface of the functional film, but a thin film (preferably less than 50 nm) that does not inhibit the function of metalloxane described below and can further improve the function of the film may be disposed on the outermost layer. The outermost layer may preferably have a thickness of 0.05 μm or more and 10 μm or less and more preferably 1 μm or more and 10 μm or less, from the viewpoints of preventing the film mirror from warping while maintaining sufficient scratch resistance.

The outermost layer contains a material having a metalloxane skeleton. Examples of the material having a metalloxane skeleton include polymethoxanes of silicon, titanium, zirconium, and aluminum; polysilazanes; perhydropolysilazanes; alkoxysilanes; alkylalkoxysilanes; and polysiloxanes. The material is preferably a polysiloxane and most preferably a polysiloxane represented by a general formula (1) below. The outermost layer is preferably formed by applying and drying such a material having a metalloxane skeleton and is preferably formed through a thermal curing reaction by a sol-gel method.

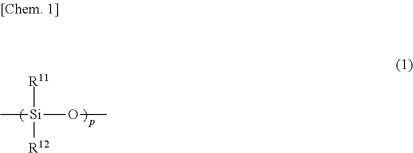

In formula (1), R¹¹ and R¹² may be the same or different and each represent hydrogen or an organic group such as alkyl or aryl group.

Examples of the polysiloxane include, but not limited to, partial hydrolysates of silane compounds having hydrolyzable silyl groups, such as tetramethoxysilane, tetraethoxysilane, methyltrimethoxysilane, methyltriethoxysilane, dimethyldimethoxysilane, dimethyldiethoxysilane, γ-glycidoxypropyltrimethoxysilane, γ-glycidoxypropyltriethoxysilane, γ-glycidoxypropylmethyldimethoxysilane, γ-glycidoxypropylmethyldiethoxysilane, γ-methacryloxypropyltrimethoxysilane, γ-methacryloxypropyltriethoxysilane, γ-methacryloxypropylmethyldimethoxysilane, γ-methacryloxypropylmethyldiethoxysilane, γ-acryloxypropyltrimethoxysilane, and γ-acryloxypropylmethyldimethoxysilane; organosilica sols of silica microparticles stably dispersed in organic solvents; and organosilica sols containing radical polymerizable silane compounds mentioned above.

The surface of the outermost layer preferably has a contact angle with water of 80° or more and less than 170° and more preferably 90° or more and 150° or less and preferably has a coefficient of dynamical friction of 0.10 or more and 0.35 or less.

For example, the contact angle with water of the outermost layer surface may be adjusted to 80° or more and less than 170° by adding a fluorine compound, a silicon compound, fluorine, or silicon to the outermost layer. More specifically, the contact angle with water of the outermost layer can be controlled to 80° or more and less than 170° by reducing the surface energy by vapor deposition of a gaseous mixture of a fluorine compound and a silicon compound or a compound including fluorine and silicon.

In order to improve the scratch resistance of the outermost layer, the coefficient of dynamical friction should be 0.10 or more and 0.35 or less and preferably in the range of 0.15 or more and 0.30 or less.

The coefficient of dynamical friction between functional films can be controlled to be 0.10 or more and 0.35 or less with a material having a metalloxane skeleton in the outermost layer.

The outermost layer preferably has a pencil hardness of H or more and 7H or less, and the number of scratches in a steel wool test under a load of 500 g/cm² preferably does not exceed 30.

### 1-1. Ultraviolet Absorber

The outermost layer contains an ultraviolet absorber. The amount of the ultraviolet absorber used is preferably 0.1% to 50% by mass, more preferably 1 to 25% by mass, and most preferably 15% to 20% by mass based on the total mass of the outermost layer. An amount not higher than 50% by mass can provide sufficient adhesion, whereas an amount not lower than 0.1% by mass can highly inhibit the deterioration of the layer due to sunlight. The ultraviolet absorber is preferably a compound showing a light transmittance of 10% or less in the UV-B region (290 to 320 nm) when an acrylic resin containing 20% by mass or more of the compound dispersed therein is formed into a film having a thickness of 6 μm.

The ultraviolet absorber may be an organic ultraviolet absorber or an inorganic ultraviolet absorber and is preferably an inorganic ultraviolet absorber.

### 1-1-1. Inorganic Ultraviolet Absorber

The inorganic ultraviolet absorber is preferably a metal oxide. Preferred examples of the metal oxide include titanium oxide, zinc oxide, cerium oxide, iron oxide, and mixtures thereof.

From the viewpoint of improving the transparency of the surface layer containing an inorganic ultraviolet absorber, the inorganic ultraviolet absorber is preferably in the form of particles having a number-average basic particle diameter between 5 to 150 nm and is most preferably metal oxide particles having a number-average basic particle diameter between 10 to 100 nm and showing a particle size distribution having a maximum particle diameter of 150 nm or less. Such coated or non-coated metal oxide pigments are described in patent application No. EP-A-0518773 in detail.

Commercially available examples of the inorganic ultraviolet absorber include Sicotrans Red L2815 (iron oxide manufactured by BASF SE), CeO-X01 (cerium oxide manufactured by Iox Co., Ltd.), NANOFINE-50 (zinc oxide manufactured by Sakai Chemical industry Co., Ltd.), STR-60 (titanium oxide manufactured by Sakai Chemical Industry Co., Ltd.), CM-1000 (iron oxide manufactured by Chemirite, Ltd.), CERIGUAPRD S-3018-02 (cerium oxide manufactured by Daito Kasei Kogyo Co., Ltd.), MZ-300 (zinc oxide manufactured by Tayca Corporation), and MT-700B (titanium oxide manufactured by Tayca Corporation).

The particle diameter of the inorganic ultraviolet absorber can be measured with a dynamic light scattering type particle size distribution measuring apparatus LB-550 (manufactured by Horiba, ltd.), and the number-average particle diameter can be determined from the outputs of the results.

The inorganic ultraviolet absorber may be used in combination with an organic ultraviolet absorber described below. In such a case, the amount of the inorganic ultraviolet absorber is 3% to 20% by mass and preferably 5% to 10% by mass based on the total mass of the outermost layer, and the amount of the organic ultraviolet absorber is 0.1% to 10% by mass and preferably 0.5% to 5% by mass based on the total mass of the outermost layer. The combined use of the inorganic ultraviolet absorber and the organic ultraviolet absorber within these ranges provides high transparency and sufficient weather resistance to the outermost layer.

### 1-1-2. Organic Ultraviolet Absorber

Examples of the organic ultraviolet absorber include benzophenone, benzotriazole, phenyl salicylate, triazine, and benzoate-based ultraviolet absorbers. In order to reduce bleeding out in use of a large amount of an ultraviolet absorber, the ultraviolet absorber is preferably a polymer having a molecular weight of 1000 or more. The molecular weight is preferably 1000 or more and 3000 or less.

Examples of the benzophenone-based ultraviolet absorber include 2,4-dihydroxy benzophenone, 2-hydroxy-4-methoxy benzophenone, 2-hydroxy-4-n-octoxy benzophenone, 2-hydroxy-4-dodecyloxy benzophenone, 2-hydroxy-4-octadecyloxy benzophenone, 2,2′-dihydroxy-4-methoxy benzophenone, 2,2′-dihydroxy-4,4′-dimethoxy benzophenone, and 2,2′,4,4′-tetrahydroxy benzophenone.

Examples of the benzotriazole-based ultraviolet absorber include 2-(2′-hydroxy-5-methylphenyl)benzotriazole, 2-(2′-hydroxy-3′,5′-di-t-butylphenyl)benzotriazole, 2-(2′-hydroxy-3′-t-butyl-5′-methylphenyl)benzotriazole, 2,2′-methylenebis[6-(2H-benzotriazol-2-yl)-4-(1,1,3,3-tetramethylbutyl)phenol] (molecular weight: 659, LA31 manufactured by Adeka Corporation is a commercially available example), and 2-(2H-benzotriazol-2-yl)-4,6-bis(i methyl-1-phenylethyl)phenol (molecular weight: 447.6, TINUVIN 234 manufactured by Ciba Specialty Chemicals Inc. is a commercially available example).

Examples of the phenyl salicylate-based ultraviolet absorber include phenyl salicylate and 2-4-di-t-butylphenyl-3,5-di-t-butyl-4-hydroxybenzoate. Examples of hindered amine ultraviolet absorbers include bis(2,2,6,6-tetramethylpyperidin-4-yl) sebacate.

Examples of the triazine-based ultraviolet absorber include 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl(2-hydroxy-4-propoxyphenyl)-1,3,5-triazine, 2,4-diphenyl(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine, [2-(4,6-diphenyl-1,3,5-triazin-2-yl)-5-(hexyl)oxyphenol](TINUVIN 1577FF, trade name, manufactured by Ciba Specialty Chemicals Inc.), and [2-[4,6-bis(2,4-dimethylphenyl)-1,3,5-triazin-2-yl]-5-(octyloxy)phenol] (CYASORB UV-1164, trade name, manufactured by Cytec Industries Inc.).

Examples of the benzoate-based ultraviolet absorber include 2,4-di-tert-butylphenyl-3,5-di-tert-butyl-4-hydroxybenzoate (molecular weight: 438.7, Sumisorb 400 manufactured by Sumitomo Chemical Co., Ltd. is a commercially available example).

### 1-2. Oxidation Inhibitor

The outermost layer may contain an oxidation inhibitor.

The oxidation inhibitor is preferably a phenol-based oxidation inhibitor, thiol-based oxidation inhibitor, or phosphate-based oxidation inhibitor.

Examples of the phenol-based oxidation inhibitor include 1,1,3-tris(2-methyl-4-hydroxy-5-t-butylphenyl) butane, 2,2′-methylenebis(4-ethyl-6-t-butylphenol), tetrakis-[methylene-3-(3′,5′-di-t-butyl-4′-hydroxyphenyl)propionate]methane, 2,6-di-t-butyl-p-cresol, 4,4′-thiobis(3-methyl-6-t-butylphenol), 4,4′-butylidenebis(3-methyl-6-t-butylphenol), 1,3,5-tris(3′,5′-di-t-butyl-4′-hydroxybenzyl)-S-triazine-2,4,6-(1H, 3H, 5H)trione, stearyl-β-(3,5-di-t-butyl-4-hydroxyphenyl)propionate, triethylene glycol bis[3-(3-t-butyl-5-methyl-4-hydroxyphenyl)propionate], 3,9-bis[1,1-di-methyl-2-[β-(3-t-butyl-4-hydroxy-5-methylphenyl)propionyloxy]ethyl]-2,4,8,10-tetraoxaspiro[5,5]undecane, and 1,3,5-trimethyl-2,4,6-tris(3,5-di-t-butyl-4-hydroxybenzyl)benzene. In particular, the phenol-based oxidation inhibitor preferably has a molecular weight of 550 or more.

Examples of the thiol-based oxidation inhibitor include distearyl 3,3′-thiodipropionate and pentaerythritol tetrakis-(β-lauryl-thiopropionate).

Examples of the phosphate-based oxidation inhibitor include tris(2,4-di-t-butyl-phenyl) phosphite, distearylpentaerythritol diphosphite, di(2,6-di-t-butylphenyl)pentaerythritol diphosphite, bis(2,6-di-t-butyl-4-methylphenyl)pentaerythritol diphosphite, tetrakis(2,4-di-t-butylphenyl) 4,4′-biphenylene diphosphonite, and 2,2′-methylenebis(4,6-di-t-butylphenyl)octyl phosphite.

The oxidation inhibitor may be used in combination with a light stabilizer described below.

Examples of hindered amine-based light stabilizers include bis(2,2,6,6-tetramethyl-4-piperidyl) sebacate, bis(1,2,2,6,6-pentamethyl-4-piperidyl) sebacate, bis(1,2,2,6,6-pentamethyl-4-piperidyl)-2-(3,5-di-t-butyl-4-hydroxybenzyl)-2-n-butyl malonate, 1-methyl-8-(1,2,2,6,6-pentamethyl-4-piperidyl) sebacate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpiperidine, 4-benzoyloxy-2,2,6,6-tetramethylpiperidine, tetrakis-(2,2,6,6-tetramethyl-4-piperidyl)-1,2,3,4-butane tetracarboxylate, triethylenediamine, and 8-acetyl-3-dodecyl-7,7,9,9-tetramethyl-1,3,8-triazaspiro[4,5]decan-2,4-dione.

In addition, a nickel-based ultraviolet light stabilizer, such as [2,2′-thiobis(4-t-octylphenolate)]-2-ethylhexylamine nickel(II), nickel complex of 3,5-di-t-butyl-4-hydroxybenzyl monoethylate phosphate, or nickel dibutyl dithiocarbamate, can be used.

In particular, the hindered amine-based light stabilizer is preferably a hindered amine-based light stabilizer containing only tertiary amine(s). Specifically preferred are bis(1,2,2,6,6-pentamethyl-4-piperidyl) sebacate, bis(1,2,2,6,6-pentamethyl-4-piperidyl)-2-(3,5-di-t-butyl-4-hydroxybenzyl-2-n-butyl malonate, and condensates of 1,2,2,6,6-pentamethyl-4-piperidinol/tridecyl alcohol and 1,2,3,4-butanetetracarboxylic acid.

### 2. Resin Substrate

A variety of known resin films can be used as a resin substrate. Examples of the resin films include cellulose ester films, polyester films, polycarbonate films, polyacrylate films, polysulfone (including polyethersulfone) films, polyester films such as polyethylene terephthalate and polyethylene naphthalate, polyethylene films, polypropylene films, cellophane, cellulose diacetate films, cellulose triacetate films, cellulose acetate propionate films, cellulose acetate butyrate films, polyvinylidene chloride films, polyvinyl alcohol films, ethylene vinyl alcohol films, syndiotactic polystyrene films, polycarbonate films, norbornene resin films, polymethylpentene films, polyether ketone films, polyether ketone imide films, polyamide films, fluorine resin films, nylon films, polymethyl methacrylate films, and acrylic films. In particular, preferred are polycarbonate films, polyester films, norbornene resin films, and cellulose ester films.

In particular, a polyester-based film or a cellulose ester-based film is preferably used. The film may be produced by melt casting or solution casting.

The resin substrate preferably has an appropriate thickness depending on the type of the resin and the purpose. For example, the thickness is usually within a range of 5 to 450 μm, preferably 10 to 200 μm, and more preferably 20 to 100 μm.

### 3. Antistatic Layer

The functional film may include an antistatic layer from the viewpoint of inhibiting the adhesion of dust and enhancing the fouling resistance. The antistatic layer can prevent the surface of the functional film from being charged. The antistatic layer is preferably disposed adjoining the outermost layer as an underlying layer of the outermost layer.

The antistatic characteristics of the antistatic layer are achieved by, for example, imparting conductivity to the antistatic layer to reduce the electrical resistivity of the antistatic layer.

Examples of the technology for achieving the antistatic characteristics include dispersion of a conductive filler as a conductive material in the antistatic layer, use of a conductive polymer, dispersion of a metal compound in the antistatic layer or coating of a surface of the antistatic layer with a metal compound, internal addition utilizing an anionic compound such as organic sulfonic acid or organic phosphoric acid, use of a surfactant low molecular-weight antistatic agent such as polyoxyethylene alkylamine, polyoxyethylene alkenyl amine, or glycerin fatty acid ester, and dispersion of conductive microparticles such as carbon black. In particular, preferred is dispersion of a conductive filler as a conductive material.

Regarding the electrical resistivity of the antistatic layer, the coating film resistance is roughly classified into intrinsic particle resistance and contact resistance. The intrinsic particle resistance is affected by the amount of metal dopant, the level of the oxygen defects, and the crystallinity of the particle. The contact resistance is affected by the diameter and shape of particles, the dispersibility of the microparticles in the coating, and the conductivity of a binder resin. Since a film having a relatively high conductivity is believed to be highly affected by the contact resistance than by the intrinsic particle resistance, it is important to form a conductive path through control of the particulate state.

The antistatic layer is preferably provided with antistatic properties by containing a conductive filler. The conductive filler contained in the antistatic layer can be conductive inorganic microparticles, in particular, metal microparticles or conductive inorganic oxide microparticles. The conductive inorganic oxide microparticles are particularly preferred. Examples of the metal microparticles include microparticles of gold, silver, palladium, ruthenium, rhodium, osmium, iridium, tin, antimony, and indium. Examples of the inorganic oxide microparticles include microparticles of indium antimony pentoxide, tin oxide, zinc oxide, indium tin oxide (ITO), antimony tin oxide (ATO), and phosphorus-doped oxides. In particular, microparticles of inorganic complex oxides such as phosphorus-doped oxide are preferred because of the high conductivity and weather resistance.

In order to reduce the transparency of the antistatic layer containing a conductive filler dispersed therein, the primary particle diameter of the conductive filler is preferably 1 to 100 nm and more preferably 1 to 50 nm. Since the particles should reside close to one another to some extent for ensuring the conductivity, the particle diameter is preferably 1 nm or more, whereas a particle diameter of higher than 100 nm causes the reflection of light to disadvantageously reduce the light transmittance.

The conductive inorganic oxide microparticles may be commercially available one, and specific examples thereof include Celnax series (manufactured by Nissan Chemical Industries, Ltd.), P-30, P-32, P-35, P-45, P-120, and P-130 (all are manufactured by JGC Catalysts and Chemicals Ltd.), and T-1, S-1, S-2000, and EP SP2 (all are manufactured by Mitsubishi Materials Electronic Chemicals Co., Ltd.).

The antistatic layer may contain a binder for retaining the conductive filler, for example, an organic binder or an inorganic binder.

The organic binder may be a resin such as an acrylic resin, cycloolefin resin, or polycarbonate resin. Alternatively, the organic binder may be a hard coat. For example, an ultraviolet-curable polyfunctional acrylic resin, urethane acrylate, epoxy acrylate, oxetane resin, or polyfunctional oxetane resin can be used. Preferred examples of the inorganic binder include inorganic oxide binders (including inorganic oxide binders prepared by a sol-gel method) and tetrafunctional inorganic binders.

Preferred examples of the inorganic oxide binder include silicon dioxide, titanium oxide, aluminum oxide, and strontium oxide. Particularly preferred is silicon dioxide. Preferred examples of the tetrafunctional inorganic binder include polysilazane (e.g., trade name: Aquamica (manufactured by AZ Electronic Materials plc)), siloxane compounds (e.g., Colcoat P (manufactured by Colcoat Co., Ltd.)), a mixture of alkyl silicate and metal alcoholate FJ803 (manufactured by GRANDEX Inc.), and alumina sol (manufactured by Kawaken Fine Chemicals Co., Ltd.). The tetrafunctional inorganic binder may be a sol-gel solution mainly composed of tetraethoxysilane and containing a catalyst.

Furthermore, the binder may be a material having both properties of an organic binder and an inorganic binder, such as polyorganosiloxane and polysilazane. Such a material is an organic binder and also an inorganic binder. Although the binder contained in the antistatic layer may be a mixture of an inorganic binder and an organic binder, sole use of an inorganic binder is preferred.

Preferably the binder is an inorganic binder because the antistatic layer can have weather resistance to ultraviolet rays and can maintain high reflectivity for a long time even in outdoor use. Since the outermost layer contains a metalloxane skeleton, an inorganic binder in the antistatic layer increases the adhesion between the antistatic layer and the outermost layer and can prevent a trouble such as a reduction in reflectivity due to peeling of the layer. Although inorganic binders readily cause cracking compared to organic binders, the outermost layer provided on the antistatic layer can prevent cracking, chipping, and scattering of chips. Thus, fragile inorganic binders can be used without causing any problem.

The antistatic layer can be formed by a known coating process such as gravure coating, reverse coating, or die coating.

The antistatic layer preferably has a thickness of 100 nm or more and 1 μm or less. If the antistatic layer is thinner than 100 nm, the conductive filler protrudes from the antistatic layer to impair the surface smoothness. An antistatic layer having a thickness larger than 1 μm causes a reduction in light transmittance.

The antistatic layer preferably contains a conductive filler (conductive inorganic microparticles) in an amount of 75% or more and 95% or less. An amount of the conductive filler less than 75% cannot lead to sufficient conductivity, whereas an amount of the conductive filler higher than 95% causes low light transmittance.

The antistatic layer is evaluated by, for example, the following method.

(Electrical Resistivity)

The electrical resistivity is measured in accordance with JIS K 7194. A sample piece taken from a film mirror is left to stand under an environment of a humidity of 50% and a temperature of 50° C. for 2 or more hours. The sample is placed on a conductive metal plate with Hiresta manufactured by Mitsubishi Chemical Corporation. The electrical resistivity of a surface of the sample is measured with a probe.

(Frictional Electrification Test)

Frictional electrification with polyester cloth is measured in accordance with the frictional electrification voltage measurement described in JIS L 1094 “Testing methods for electrostatic propensity of woven and knitted fabrics”. The friction cloth used is Polyester 8-2 described in JIS L 0803 “Standard adjacent fabrics for staining of color fastness test”, and a surface of a sample piece taken from a film mirror is frictionally charged to determine the electrification voltage of the sample surface.

(Dust Adhesion Test (Ash Test))

A size A4 sample piece taken from a film mirror is humidified in a testing atmosphere of 23° C. and 30% RH for 24 hours. The surface of the humidified film mirror piece is rubbed with a friction cloth (100% wool) by ten cycles of reciprocating motions. Subsequently, the film mirror piece is immediately brought close to cigarette ash predried at 70° C. for 1 hour, and the distance at which the ash adheres to the sample is measured. Samples ranked to “A” or “B” in the following criteria are acceptable.

A: Ash does not adhere to the film being in contact with the ash;

B: Ash adheres to the film being in contact with the ash; and

C: Ash adheres to the film brought close to the ash.

### 4. Silver Layer

The functional film used as a heat barrier film or a film mirror preferably includes a silver layer (silver reflection layer). The silver layer is mainly composed of silver. In the silver layer of a film mirror, the reflectivity of the surface to sunlight is preferably 80% or more and more preferably 90% or more. The silver layer of a heat barrier film preferably reflects infrared rays and transmits visible light. The thickness of the silver layer of a film mirror is preferably 30 nm or more and 200 nm or less. The thickness of the silver layer of a heat barrier film is preferably 0.1 nm or more and 50 nm or less and more preferably 5 nm or more and 50 nm or less.

The silver layer may be formed by either a wet or dry process. The wet process is the general term for a plating process and involves the formation of a film by deposition of elemental metal from a solution. A specific example thereof is a silver mirror reaction. The dry process is the general term for vacuum film formation, and specific examples thereof include resistance heating vacuum deposition, electron beam heating vacuum deposition, ion plating, ion beam assisted vacuum deposition, and sputtering. In particular, preferably used is vapor deposition that can employ a roll-to-roll system continuously forming films.

### 4-1. Silver Complex Having Vaporizable and Desorbable Ligand

The silver layer may be formed by firing a coated film containing a silver complex containing a ligand that can be vaporized and desorbed during the formation of the silver layer.

The “silver complex containing a ligand that can be vaporized and desorbed” refers to a silver complex containing a ligand for stably dissolving silver in a solution and allowing only elemental silver to remain as a result of thermal decomposition of the ligand into CO₂ and a low-molecular-weight amine compound and vaporization and desorption through removal of the solvent during firing of the compound.

Examples of such complexes are described in Japanese National Publication of International Patent Application Nos. 2009-535661 and 2010-500475. The silver complex is preferably prepared by a reaction of a silver compound represented by a general formula (2) and an ammonium carbamate compound or ammonium carbonate compound represented by a general formula (3), (4), or (5).

The silver complex is contained in a solution silver coating composition, and the composition is applied onto a resin substrate to form a coating film containing the complex. That is, the silver layer is preferably formed by forming a coating film on a film from a silver complex and then firing the coating film at a temperature within a range of 80° C. to 250° C., more preferably 100° C. to 220° C., and most preferably 120° C. to 200° C. The firing process may be performed by any known common method.

The silver compound represented by the formula (2) and the ammonium carbamate compound and ammonium carbonate compound represented by the formula (3), (4), or (5) will be described.

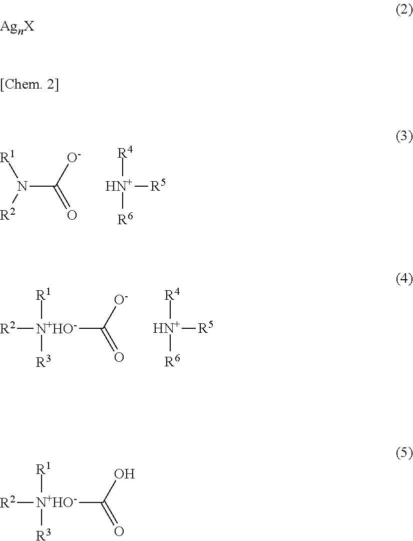

(In the formulae (2) to (5), X represents a substituent selected from oxygen, sulfur, halogens, cyano, cyanates, carbonates, nitrates, nitrides, sulfates, phosphates, thiocyanates, chlorates, perchlorates, tetrafluoroborates, acetylacetonates, carboxylates, and derivatives thereof; n is an integer of 1 to 4; R¹ to R⁶ each independently represent a substituent selected from hydrogen, C1 to C30 aliphatic and alicyclic alkyl groups, aryl groups, aralkyl groups, functional group-substituted alkyl and aryl groups, heterocyclic groups, high-molecular-weight compounds, and derivatives thereof).

Specific examples of the compound represented by the formula (2) include, but not limited to, silver oxide, silver thiocyanate, silver sulfide, silver chloride, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate, and derivatives thereof.

In the formulae (3) to (5), specific examples of the substituents represented by R¹ to R⁶ include, but not limited to, hydrogen, methyl, ethyl, propyl, isopropyl, butyl, isobutyl, amyl, hexyl, ethylhexyl, heptyl, octyl, isooctyl, nonyl, decyl, dodecyl, hexadecyl, octadecyl, docodecyl, cyclopropyl, cyclopentyl, cyclohexyl, aryl, hydroxy, methoxy, hydroxyethyl, methoxyethyl, 2-hydroxypropyl, methoxypropyl, cyanoethyl, ethoxy, butoxy, hexyloxy, methoxyethoxyethyl, methoxyethoxyethoxyethyl, hexamethyleneimino, morpholinyl, piperidinyl, piperazinyl, ethylenediamino, propylenediamino, hexamethylenediamino, triethylenediamino, pyrrolyl, imidazolyl, pyridinyl, carboxymethyl, trimethoxysilylpropyl, triethoxysilylpropyl, phenyl, methoxyphenyl, cyanophenyl, phenoxy, tolyl, benzyl, and derivatives thereof; and polymeric compounds, such as polyarylamines and polyethyleneamines, and derivatives thereof.

Specific examples of the compounds represented by the formulae (3) to (5) include, but not limited to, ammonium carbamate, ammonium carbonate, ammonium bicarbonate, ethylammonium ethylcarbamate, isopropylammonium isopropylcarbamate, n-butylammonium n-butylcarbamate, isobutylammonium isobutylcarbamate, t-butylammonium t-butylcarbamate, 2-ethylhexylammonium 2-ethylhexylcarbamate, octadecylammonium octadecylcarbamate, 2-methoxyethylammonium 2-methoxyethylcarbamate, 2-cyanoethylammonium 2-cyanoethylcarbamate, dibutylammonium dibutylcarbamate, dioctadecylammonium dioctadecylcarbamate, methyldecylammonium methyldecylcarbamate, hexamethyleneimineammonium hexamethyleneiminecarbamate, morpholinium morpholinecarbamate, pyridium ethylhexylcarbamate, triethylenediaminium isopropylbicarbamate, benzylammonium benzylcarbamate, triethoxysilylpropylammonium triethoxysilylpropylcarbamate, ethylammonium ethylcarbonate, isopropyl ammonium isopropylcarbonate, isopropylammonium bicarbonate, n-butylammonium n-butylcarbonate, isobutylammonium isobutylcarbonate, t-butylammonium t-butylcarbonate, t-butylammonium bicarbonate, 2-ethylhexylammonium 2-ethylhexylcarbonate, 2-ethylhexylammonium bicarbonate, 2-methoxyethylammonium 2-methoxyethylcarbonate, 2-methoxyethylammonium bicarbonate, 2-cyanoethylammonium 2-cyanoethylcarbonate, 2-cyanoethylammonium bicarbonate, octadecylammonium octadecylcarbonate, dibutylammonium dibutylcarbonate, dioctadecylammonium dioctadecylcarbonate, dioctadecylammonium bicarbonate, methyldecylammonium methyldecylcarbonate, hexamethyleneimineammonium hexamethyleneiminecarbonate, morpholineammonium morpholinecarbonate, benzylammonium benzylcarbonate, triethoxysilylpropylammonium triethoxysilylpropylcarbonate, pyridium bicarbonate, triethylenediaminium isopropylcarbonate, triethylenediaminium bicarbonate, and derivatives thereof; and mixtures of two or more thereof.

The ammonium carbamate and ammonium carbonate compounds may be of any types and may be produced by any method. For example, according to U.S. Pat. No. 4,542,214, an ammonium carbamate compound can be produced from a primary amine, a secondary amine, a tertiary amine, or a mixture of at least one of them and carbon dioxide. Furthermore, addition of 0.5 mol of water for 1 mol of the amine gives an ammonium carbonate compound while addition of 1 mol or more of water gives an ammonium bicarbonate compound. On this occasion, the ammonium carbamate or ammonium carbonate compound may be directly produced without a specific solvent under an ordinary or pressurized state or may be produced in a solvent. Examples of the solvent include water; alcohols such as methanol, ethanol, 2-propanol, and butanol; glycols such as ethylene glycol and glycerin; acetates such as ethyl acetate, butyl acetate, and carbitol acetate; ethers such as diethyl ether, tetrahydrofuran, and dioxane; ketones such as methyl ethyl ketone and acetone; hydrocarbon solvents such as hexane and heptane; aromatic solvents such as benzene and toluene; halogenated solvents such as chloroform, methylene chloride, and carbon tetrachloride; and solvent mixtures thereof. Carbon dioxide can be used in a gaseous state by bubbling or in a solid state, i.e., in the form of dry ice or also can react in a supercritical state. The ammonium carbamate or ammonium carbonate derivative may be produced by any other known method which can form a final product having the same structure, in addition to the above-mentioned methods. That is, the solvent, reaction temperature, concentration, catalyst, and other factors for the production are not limited and do not affect the production yield.

An organic silver complex can be produced by a reaction of the resultant ammonium carbamate or ammonium carbonate compound with a silver compound. For example, an organic silver complex can be produced by direct reaction of at least one silver compound represented by the formula (2) and at least one of the ammonium carbamate or ammonium carbonate derivatives represented by the formula (3), (4), or (5) or a mixture thereof without a specific solvent under an ordinary or pressurized nitrogen atmosphere or can be produced in a solvent. Examples of the solvent include water; alcohols such as methanol, ethanol, 2-propanol, and butanol; glycols such as ethylene glycol and glycerin; acetates such as ethyl acetate, butyl acetate, and carbitol acetate; ethers such as diethyl ether, tetrahydrofuran, and dioxane; ketones such as methyl ethyl ketone and acetone; hydrocarbon solvents such as hexane and heptane; aromatic solvents such as benzene and toluene; halogenated solvents such as chloroform, methylene chloride, and carbon tetrachloride; and solvent mixtures thereof.

Alternatively, the silver complex can also be produced by preparing a solution containing a silver compound represented by the formula (2) and one or more amine compounds and reacting the solutes with carbon dioxide. As described above, the reaction can be directly performed without any solvent under an ordinary or pressurized nitrogen atmosphere or in a solvent. The silver complex may be produced by any known method that can produce a final product having the same structure. That is, the solvent, reaction temperature, concentration, use of catalyst, and other factors for the production are not limited and do not affect the production yield.

The method of producing the silver complex is described in Japanese National Publication of International Patent Application No. 2008-530001. The silver complex can be identified by a structure represented by a general formula (6).

Ag[A]ₘ (6)

(In the formula (6), A represents a compound represented by the formula (3), (4), or (5), and m is 0.5 to 1.5.)

A solution silver coating composition used for forming a reflective surface with high reflection and high gloss contains the silver complex and optionally contains a solvent and additives, i.e., a stabilizer, a leveling agent, a thin-film auxiliary agent, a reducing agent, and a thermal decomposition enhancer. The silver coating composition of the present invention can contain additives: an auxiliary agent, a reducing agent, and a thermal decomposition enhancer.

Examples of the stabilizer include amine compounds such as primary amines, secondary amines, and tertiary amines; ammonium carbamate, ammonium carbonate, and ammonium bicarbonate compounds which are mentioned above; phosphorus compounds such as phosphines, phosphites, and phosphates; sulfur compounds such as thiols and sulfides; and mixtures thereof. Specific examples of the amine compounds include methylamine, ethylamine, n-propylamine, isopropylamine, n-butylamine, isobutylamine, isoamylamine, n-hexylamine, 2-ethylhexylamine, n-heptylamine, n-octylamine, isooctylamine, nonylamine, decylamine, dodecylamine, hexadecylamine, octadecylamine, docodecylamine, cyclopropylamine, cyclopentylamine, cyclohexylamine, arylamine, hydroxyamine, ammonium hydroxide, methoxyamine, 2-ethanolamine, methoxyethylamine, 2-hydroxypropylamine, 2-hydroxy-2-methylpropylamine, methoxypropylamine, cyanoethylamine, ethoxyamine, n-butoxyamine, 2-hexyloxyamine, methoxyethoxyethylamine, methoxyethoxyethoxyethylamine, dimethylamine, dipropylamine, diethanolamine, hexamethyleneimine, morpholine, piperidine, piperazine, ethylenediamine, propylenediamine, hexamethylenediamine, triethylenediamine, 2,2-(ethylenedioxy)bisethylamine, triethylamine, triethanolamine, pyrrole, imidazole, pyridine, aminoacetoaldehyde dimethylacetal, 3-aminopropyltrimethoxysilane, 3-aminopropyltriethoxysilane, aniline, anisidine, aminobenzonitrile, benzylamine, and derivatives thereof; and high-molecular-weight amine compounds, such as polyarylamine and polyethyleneimine, and derivatives thereof.

Specific examples of the ammonium carbamate, carbonate, and bicarbonate compounds include ammonium carbamate, ammonium carbonate, ammonium bicarbonate, ethylammonium ethylcarbamate, isopropylammonium isopropylcarbamate, n-butylammonium n-butylcarbamate, isobutylammonium isobutylcarbamate, t-butylammonium t-butylcarbamate, 2-ethylhexylammonium 2-ethylhexylcarbamate, octadecylammonium octadecylcarbamate, 2-methoxyethylammonium 2-methoxyethylcarbamate, 2-cyanoethylammonium 2-cyanoethylcarbamate, dibutylammonium dibutylcarbamate, dioctadecylammonium dioctadecylcarbamate, methyldecylammonium methyldecylcarbamate, hexamethyleneimineammonium hexamethyleneiminecarbamate, morpholinium morpholinecarbamate, pyridium ethyhexylcarbamate, triethylenediaminium isopropylbicarbamate, benzylammonium benzylcarbamate, triethoxysilylpropylammonium triethoxysilylpropylcarbamate, ethylammonium ethylcarbonate, isopropylammonium isopropylcarbonate, isopropylammonium bicarbonate, n-butylammonium n-butylcarbonate, isobutylammonium isobutylcarbonate, t-butylammonium t-butylcarbonate, t-butylammonium bicarbonate, 2-ethylhexylammonium 2-ethylhexylcarbonate, 2-ethylhexylammonium bicarbonate, 2-methoxyethylammonium 2-methoxyethylcarbonate, 2-methoxyethylammonium bicarbonate, 2-cyanoethylammonium 2-cyanoethylcarbonate, 2-cyanoethylammonium bicarbonate, octadecylammonium octadecylcarbonate, dibutylammonium dibutylcarbonate, dioctadecylammonium dioctadecylcarbonate, dioctadecylammonium bicarbonate, methyldecylammonium methyldecylcarbonate, hexamethyleneimineammonium hexamethyleneiminecarbonate, morpholineammonium morpholinecarbonate, benzylammonium benzylcarbonate, triethoxysilylpropylammonium triethoxysilylpropylcarbonate, pyridium bicarbonate, triethylenediaminium isopropylcarbonate, triethylenediaminium bicarbonate, and derivatives thereof.

Examples of the phosphorus compound include those represented by formulae R₃P, (RO)₃P, and (RO)₃PO, wherein R represents an alkyl or aryl group having 1 to 20 carbon atoms. Specific examples of the phosphorus compound include tributylphosphine, triphenylphosphine, triethylphosphite, triphenylphosphite, dibenzylphosphate, and triethylphosphate.

Specific examples of the sulfur compound include butanethiol, n-hexanethiol, diethylsulfide, tetrahydrothiophene, aryldisulfide, 2-mercaptobenzoazole, tetrahydrothiophene, and octyl thioglycolate.

Such a stabilizer may be contained in any amount that satisfies the ink properties required for the present invention. The molar percent of the stabilizer to the silver compound is preferably 0.1% to 90%.

Examples of the thin-film auxiliary agent include organic acids, organic acid derivatives, and mixtures thereof, and specific examples thereof include organic acids such as acetic acid, butyric acid, valeric acid, pivalic acid, hexanoic acid, octanoic acid, 2-ethyl-hexanoic acid, neodecanoic acid, lauric acid, stearic acid, and naphthalic acid. Specific examples of the organic acid derivatives include ammonium salts of organic acids such as ammonium acetate, ammonium citrate, ammonium laurate, ammonium lactate, ammonium maleate, ammonium oxalate, and ammonium molybdate; and salts of organic acids with metals such as Au, Cu, Zn, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Sm, Eu, Ac, and Th, e.g., manganese oxalate, gold acetate, palladium oxalate, silver 2-ethylhexanoate, silver octanoate, silver neodecanoate, cobalt stearate, nickel naphthalate, and cobalt naphthalate. The thin-film auxiliary agent may be contained in any amount. The molar percent of the thin-film auxiliary agent to the silver complex is preferably 0.1% to 25%.

Examples of the reducing agent include Lewis acids and weak bronsted acids. Specific examples of the reducing agent include hydrazine, hydrazine monohydrate, acetohydrazide, boron-sodium hydroxide, boron-potassium hydroxide; amine compounds such as dimethylamine borane and butylamine borane; metal salts such as ferrous chloride and iron lactate; hydrogen; hydrogen iodide; carbon monoxide; aldehyde compounds such as formaldehyde, acetoaldehyde, and glyoxal; formic acid compounds such as methyl formate, butyl formate, triethyl o-formate; reductive organic compounds such as glucose, ascorbic acid, and hydroquinone; and mixtures thereof.

Specific examples of the thermal decomposition enhancer include hydroxyalkylamines such as ethanolamine, methyldiethanolamine, triethanolamine, propanolamine, butanolamine, hexanolamine, and dimethylethanolamine; amine compounds such as piperidine, N-methylpiperidine, piperazine, N,N′-dimethylpiperazine, 1-amino-4-methylpiperazine, pyrrolidine, N-methylpyrrolidine, and morpholine; alkyl oximes such as acetone oxime, dimethylglyoxime, 2-butanone oxime, and 2,3-butadione monoxime; glycols such as ethylene glycol, diethylene glycol, and triethylene glycol; alkoxyalkylamines such as methoxyethylamine, ethoxyethylamine, and methoxypropylamine; alkoxyalkanols such as methoxyethanol, methoxypropanol, and ethoxyethanol; ketones such as acetone, methyl ethyl ketone, and methyl isobutyl ketone; ketone alcohols such as acetol and diacetone alcohol; polyhydric phenol compounds; phenol resins; alkyd resins; and oxidation polymerizable resins such as pyrrole and ethylene dioxythiophene (EDOT).

A solvent may be necessary for adjusting the viscosity of the solution silver coating composition or for smoothly forming a thin film. Examples of usable solvent in such a case include water; alcohols such as methanol, ethanol, 2-propanol, 1-methoxypropanol, butanol, ethylhexyl alcohol, and terpineol; glycols such as ethylene glycol and glycerin; acetates such as ethyl acetate, butyl acetate, methoxypropyl acetate, carbitol acetate, and ethylcarbitol acetate; ethers such as methyl cellosolve, butyl cellosolve, diethyl ether, tetrahydrofuran, and dioxane; ketones such as methyl ethyl ketone, acetone, dimethylformamide, and 1-methyl-2-pyrrolidone; hydrocarbon solvents such as hexane, heptane, dodecane, paraffin oil, and mineral spirit; aromatic solvents such as benzene, toluene, and xylenes; halogenated solvents such as chloroform, methylene chloride, and carbon tetrachloride; acetonitrile; dimethylsulfoxide; and solvent mixtures thereof.

### 4-2. Nitrogen-containing Cyclic Compound in Layer Adjoining Silver Layer

When the silver layer is formed by firing a coated film containing a silver complex containing a ligand that can be vaporized and desorbed, a layer adjoining the silver layer preferably contains a nitrogen-containing cyclic compound. Nitrogen-containing cyclic compounds preferably used are roughly classified into corrosion inhibitors and oxidation inhibitors having silver-adsorbing groups.

The use of the nitrogen-containing cyclic compound as the corrosion inhibitor having a silver-adsorbing group can provide a desired corrosion inhibiting effect. For example, the corrosion inhibitor is preferably at least one selected from compounds having pyrrole rings, compounds having triazole rings, compounds having pyrazole rings, compounds having imidazole rings, compounds having indazole rings, and mixtures thereof.

Examples of the compounds having pyrrole rings include N-butyl-2,5-dimethylpyrrole, N-phenyl-2,5-dimethylpyrrole, N-phenyl-3-formyl-2,5-dimethylpyrrole, N-phenyl-3,4-diformyl-2,5-dimethylpyrrole, and mixtures thereof.

Examples of the compounds having triazole rings include 1,2,3-triazole, 1,2,4-triazole, 3-mercapto-1,2,4-triazole, 3-hydroxy-1,2,4-triazole, 3-methyl-1,2,4-triazole, 1-methyl-1,2,4-triazole, 1-methyl-3-mercapto-1,2,4-triazole, 4-methyl-1,2,3-triazole, benzotriazole, tolyltriazole, 1-hydroxybenzotriazole, 4,5,6,7-tetrahydrotriazole, 3-amino-1,2,4-triazole, 3-amino-5-methyl-1,2,4-triazole, carboxybenzotriazole, 2-(2′-hydroxy-5′-methylphenyl)benzotriazole, 2-(2′-hydroxy-5′-tert-butylphenyl)benzotriazole, 2-(2′-hydroxy-3′5′-di-tert-butylphenyl)benzotriazole, 2-(2′-hydroxy-4-octoxyphenyl)benzotriazole, and mixtures thereof.

Examples of the compounds having pyrazole rings include pyrazole, pyrazoline, pyrazolone, pyrazolidine, pyrazolidone, 3,5-dimethylpyrazole, 3-methyl-5-hydroxypyrazole, 4-aminopyrazole, and mixtures thereof.

Examples of the compounds having imidazole rings include imidazole, histidine, 2-heptadecylimidazole, 2-methylimidazole, 2-ethyl-4-methylimidazole, 2-phenylimidazole, 2-undecylimidazole, 1-benzyl-2-methylimidazole, 2-phenyl-4-methylimidazole, 1-cyanoethyl-2-methylimidazole, 1-cyanoethyl-2-phenylimidazole, 1-cyanoethyl-2-ethyl-4-methyl imidazole, 1-cyanoethyl-2-undecylimidazole, 2-phenyl-4-methyl-5-hydromethylimidazole, 2-phenyl-4,5-dihydroxymethylimidazole, 4-formylimidazole, 2-methyl-4-formylimidazole, 2-phenyl-4-formylimidazole, 4-methyl-5-formylimidazole, 2-ethyl-4-methyl-5-formylimidazole, 2-phenyl-4-methyl-4-formylimidazole, 2-mercaptobenzoimidazole, and mixtures thereof.

Examples of the compounds having indazole rings include 4-chloroindazole, 4-nitroindazole, 5-nitroindazole, 4-chloro-5-nitroindazole, and mixtures thereof.

### 5. Corrosion Inhibitor-Containing Layer

In the functional film including a silver layer, a layer adjoining the silver layer is preferably a corrosion inhibitor-containing layer. The outermost layer may also serve as the corrosion inhibitor-containing layer or the resin substrate may serve as the corrosion inhibitor-containing layer. Alternatively, a corrosion inhibitor-containing layer may be disposed so as to adjoin the silver layer independently from the outermost layer and the resin substrate.

The corrosion inhibitor preferably has a silver-adsorbing group. Throughout the specification, the term “corrosion” refers to a phenomenon that a metal (silver) is chemically or electrochemically eroded or is deteriorated in quality by environmental materials therearound (see JIS Z0103-2004). The optimum amount of the corrosion inhibitor varies depending on the compound used. The preferred amount is usually within a range of 0.1 to 1.0 g/m².

The corrosion inhibitor having a silver-adsorbing group is preferably at least one selected from amines and derivatives thereof, compounds having pyrrole rings, compounds having triazole rings such as benzotriazole, compounds having pyrazole rings, compounds having thiazole rings, compounds having imidazole rings, compounds having indazole rings, copper chelate compounds, thioureas, compounds having mercapto groups, naphthalene compounds, and mixtures thereof. Some compounds such as benzotriazole can serve as both an ultraviolet absorber and a corrosion inhibitor. The corrosion inhibitor may be a silicone-modified resin. Any silicone-modified resin can be used.

Examples of the amines and derivatives thereof include ethylamine, laurylamine, tri-n-butylamine, O-toluidine, diphenylamine, ethylenediamine, diethylenetriamine, triethylenetetramine, tetraethylenepentamine, monoethanolamine, diethanolamine, triethanolamine, 2N-dimethylethanolamine, 2-amino-2-methyl-1,3-propanediol, acetamide, acrylamide, benzamide, p-ethoxychrysoidine, dicyclohexylammonium nitrite, dicyclohexylammonium salicylate, monoethanolamine benzoate, dicyclohexylammonium benzoate, diisopropylammonium benzoate, diisopropylammonium nitrite, cyclohexylamine carbamate, nitronaphthaleneammonium nitrite, cyclohexylamine benzoate, dicyclohexylammonium cyclohexanecarboxylate, cyclohexylamine cyclohexanecarboxylate, dicyclohexylammonium acrylate, cyclohexylamine acrylate, and mixtures thereof.

Examples of the compounds having pyrrole rings include N-butyl-2,5-dimethylpyrrole, N-phenyl-2,5-dimethylpyrrole, N-phenyl-3-formyl-2,5-dimethylpyrrole, N-phenyl-3,4-diformyl-2,5-dimethylpyrrole, and mixtures thereof.

Examples of the compounds having triazole rings include 1,2,3-triazole, 1,2,4-triazole, 3-mercapto-1,2,4-triazole, 3-hydroxy-1,2,4-triazole, 3-methyl-1,2,4-triazole, 1-methyl-1,2,4-triazole, 1-methyl-3-mercapto-1,2,4-triazole, 4-methyl-1,2,3-triazole, benzotriazoe, tolyltriazole, 1-hydroxybenzotriazole, 4,5,6,7-tetrahydrotriazole, 3-amino-1,2,4-triazole, 3-amino-5-methyl-1,2,4-triazole, carboxybenzotriazole, 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-4-octoxyphenyl)benzotriazole, 2-(2′-hydroxy-3′-t-butyl-5′-methylphenyl)benzotriazole, 2,2′-methylenebis[6-(2H-benzotriazol-2-yl)-4-(1,1,3,3-tetramethylbutyl)phenol] (molecular weight: 659, LA31 manufactured by Adeka Corporation is a commercially available example), 2-(2H-benzotriazol-2-yl)-4,6-bis(1-methyl-1-phenylethyl)phenol (molecular weight: 447.6, TINUVIN 234 manufactured by Ciba Specialty Chemicals Inc. is a commercially available example), and mixtures thereof.

Examples of the compounds having pyrazole rings include pyrazole, pyrazoline, pyrazolone, pyrazolidine, pyrazolidone, 3,5-dimethylpyrazole, 3-methyl-5-hydroxypyrazole, 4-aminopyrazole, and mixtures thereof.

Examples of the compounds having thiazole rings include thiazole, thiazoline, thiazolone, thiazolidine, thiazolidone, isothiazole, benzothiazole, 2-N,N-diethylthiobenzothiazole, P-dimethylaminobenzalrhodanine, 2-mercaptobenzothiazole, and mixtures thereof.

Examples of the compounds having imidazole rings include imidazole, histidine, 2-heptadecylimidazole, 2-methylimidazole, 2-ethyl-4-methylimidazole, 2-phenylimidazole, 2-undecylimidazole, 1-benzyl-2-methylimidazole, 2-phenyl-4-methylimidazole, 1-cyanoethyl-2-methylimidazole, 1-cyanoethyl-2-phenylimidazole, 1-cyanoethyl-2-ethyl-4-methylimidazole, 1-cyanoethyl-2-undecylimidazole, 2-phenyl-4-methyl-5-hydromethylimidazole, 2-phenyl-4,5-dihydroxymethylimidazole, 4-formylimidazole, 2-methyl-4-formylimidazole, 2-phenyl-4-formylimidazole, 4-methyl-5-formylimidazole, 2-ethyl-4-methyl-5-formylimidazole, 2-phenyl-4-methyl-4-formylimidazole, 2-mercaptobenzoimidazole, and mixtures thereof.

Examples of the compounds having indazole rings include 4-chloroindazole, 4-nitroindazole, 5-nitroindazole, 4-chloro-5-nitroindazole, and mixtures thereof.

Examples of the copper chelate compounds include acetylacetone copper, ethylenediamine copper, phthalocyanine copper, ethylenediamine tetraacetate copper, hydroxyquinoline copper, and mixtures thereof.

Examples of the thioureas include thiourea, guanylthiourea, and mixtures thereof.

Examples of the compounds having mercapto rings include mercaptoacetic acid, thiophenol, 1,2-ethanediol, 3-mercapto-1,2,4-triazole, 1-methyl-3-mercapto-1,2,4-triazole, 2-mercaptobenzothiazole, 2-mercaptobenzoimidazole, glycol dimercaptoacetate, 3-mercaptopropyltrimethoxysilane, and mixtures thereof, some of which are described above.

Examples of the naphthalene compounds include thionalide.

The corrosion inhibitor may be the oxidation inhibitor described in “1-2. Oxidation Inhibitor” above.

### 6. Gas Barrier Layer

The functional film including a silver layer may further include a gas barrier layer adjacent to the light incidence side relative to the silver layer. The gas barrier layer is preferably disposed between the outermost layer and the silver layer. The gas barrier layer prevents deterioration due to a variation in humidity, in particular, due to high humidity of each layer supported by the resin substrate and may further have a specific function or use. Accordingly, the gas barrier layer may be of any form that maintains the deterioration-preventing function. The outermost layer may also serves as a gas barrier layer.

The gas barrier layer preferably has moisture barrier properties such that the water vapor transmittance is preferably 1 g/m²·day or less, more preferably 0.5 g/m²·day or less, and most preferably 0.2 g/m²·day or less at 40° C. and 90% RH. The gas barrier layer preferably has an oxygen transmittance of 0.6 mL/m²/day/atm or less measured at a temperature of 23° C. and a humidity of 90% RH.

The gas barrier layer is formed by, for example, formation of an inorganic oxide through a process such as vacuum deposition, sputtering, ion beam assisted vacuum deposition, or chemical vapor deposition. An inorganic oxide layer is also preferably formed by application of a precursor of an inorganic oxide by a sol-gel method and then subjecting the coated film to heating and/or ultraviolet irradiation.

### 6-1. Inorganic Oxide

The inorganic oxide is formed from a sol of an organometallic compound as a raw material by local heating. The inorganic oxide is an oxide of an element contained in the organometallic compound, such as silicon (Si), aluminum (Al), zirconium (Zr), titanium (Ti), tantalum (Ta), zinc (Zn), barium (Ba), indium (In), tin (Sn), and niobium (Nb), and specific examples thereof include silicon oxide, aluminum oxide, and zirconium oxide. In particular, silicon oxide is preferred.

The inorganic oxide is preferably formed by a sol-gel method or polysilazane method. The sol-gel and polysilazane methods can also be applied to formation of the outermost layer made of methalloxane. The sol-gel method forms an inorganic oxide from an organometallic compound which is a precursor of the inorganic oxide, whereas the polysilazane method forms an inorganic oxide from polysilazane which is a precursor of the inorganic oxide.

### 6-2. Precursor of Inorganic Oxide

The gas barrier layer can be formed through application of a precursor that forms an inorganic oxide through a common heating process. Preferably, the gas barrier layer is formed by local heating. The precursor is preferably an organometallic compound in a sol state or polysilazane.

### 6-3. Organometallic Compound

The organometallic compound preferably contains at least one element selected from silicon (Si), aluminum (Al), lithium (Li), zirconium (Zr), titanium (Ti), tantalum (Ta), zinc (Zn), barium (Ba), indium (In), tin (Sn), lanthanum (La), yttrium (Y), and niobium (Nb). In particular, the organometallic compound preferably contains at least one element selected from silicon (Si), aluminum (Al), lithium (Li), zirconium (Zr), titanium (Ti), zinc (Zn), and barium (Ba), and more preferably at least one element selected from silicon (Si), aluminum (Al), and lithium (Li).

The organometallic compound may be any hydrolyzable compound and is preferably a metal alkoxide. The metal alkoxide is represented by a general formula (7):

MR²ₘ(OR¹)ₙ₋ₘ (7)

In the formula (7), M represents a metal having an oxidation number n; R¹ and R² each independently represent an alkyl group; and m represents an integer of 0 to (n-1). R¹ and R² may be the same or different and are each preferably an alkyl group having 4 or less carbon atoms, e.g., a lower alkyl group such as a methyl group CH₃ (hereinafter, referred to as Me), an ethyl group C₂H₅ (hereinafter, referred to as Et), a propyl group C₃H₇ (hereinafter, referred to as Pr), an isopropyl group i-C₃H₇ (hereinafter, referred to as i-Pr), a butyl group C₄H₉ (hereinafter, referred to as Bu), or an isobutyl group i-C₄H₉ (hereinafter, referred to as i-Bu).

Preferred examples of the metal alkoxide represented by the formula (7) include lithium ethoxide LiOEt, niobium ethoxide Nb(OEt)₅, magnesium isopropoxide Mg(OPr-i)₂, aluminum isopropoxide Al(OPr-i)₃, zinc propoxide Zn(OPr)₂, tetraethoxysilane Si(OEt)₄, titanium isopropoxide Ti(OPr-i)₄, barium ethoxide Ba(OEt)₂, barium isopropoxide Ba(OPr-i)₂, triethoxyborane B(OEt)₃, zirconium propoxide Zn(OPr)₄, lanthanum propoxide La(OPr)₃, yttrium propoxide Y(OPr)₃, and lead isopropoxide Pb(OPr-i)₂. These metal alkoxides are readily commercially available. Low condensation products of metal alkoxides prepared by partial hydrolysis are also commercially available and can also be used as raw materials.

### 6-4. Sol-Gel Method

Throughout the specification, the term “sol-gel method” refers to a method of preparing metal oxide glass with a certain shape (e.g., in a form of film, particle, or fiber) by preparing a hydroxide sol through, for example, hydrolysis of an organometallic compound and dehydration of the sol into a gel and then heating the gel. A multicomponent metal oxide glass can also be prepared by, for example, a method of mixing different sol solutions or a method of adding other metal ions to the system. Specifically, an inorganic oxide is preferably produced by a sol-gel method including the following steps.

That is, from the viewpoint of avoiding occurrence of micropores and degradation of the film by high-temperature heat treatment, it is particularly preferred to produce an inorganic oxide by a sol-gel method including a step of hydrolyzation and dehydrative condensation of an organometallic compound in a reaction solution at least containing water and an organic solvent, with halide ions as a catalyst in the presence of boron ions, at a pH of 4.5 to 5.0 to prepare a reaction product; and a step of heating the reaction product at 200° C. or less to vitrify it.

In this sol-gel method, the organometallic compound used as a raw material may be any hydrolyzable compound, and preferred examples of the organometallic compound include metal alkoxides mentioned above.

In the sol-gel method, the organometallic compound may be directly used in the reaction and is preferably used in a form diluted with a solvent for ready control of the reaction. The solvent for dilution may be any solvent that can dissolve the organometallic compound and is uniformly miscible with water. Preferred examples of such solvents for dilution include lower aliphatic alcohols such as methanol, ethanol, propanol, 2-propanol, butanol, 2-methylpropan-1-ol, ethylene glycol, propylene glycol, and mixtures thereof. In addition, for example, a solvent mixture of butanol, cellosolve, and butyl cellosolve or a solvent mixture of xylose, cellosolve acetate, methyl isobutyl ketone, and cyclohexane can be used.

An organometallic compound containing Ca, Mg, or Al as the metal, forms precipitation of a hydroxide through a reaction with water in the reaction solution or of a carbonate in the presence of carbonate ions CO₃²⁻. Accordingly, it is preferable to add an alcoholic solution of triethanolamine as a masking agent to the reaction solution. The organometallic compound is preferably dissolved in a solvent at a concentration of 70% by mass or less and is more preferably used in a form diluted within a range of 5% to 70% by mass.

The reaction solution used in the sol-gel method contains at least water and an organic solvent. The organic solvent may be any solvent that forms a homogeneous solution with water, an acid, and an alkali, and preferred examples thereof include lower aliphatic alcohols that are used for dilution of the organometallic compound. The lower aliphatic alcohol is preferably propanol, 2-propanol, butanol, or iso-butanol, which has carbon atoms larger than that of methanol or ethanol, for stable growth of the resulting film of metal oxide glass. In this reaction solution, the amount of water is preferably in the range of 0.2 to 50 mol/L.

In the sol-gel method, an organometallic compound is hydrolyzed in a reaction solution in the presence of boron ions with halide ions as a catalyst. Preferred examples of compounds providing boron ions B³⁺ include trialkoxyboranes B(OR)₃. In particular, preferred is triethoxyborane B(OEt)₃. The concentration of the B³⁺ ions in the reaction solution is preferably in the range of 1.0 to 10.0 mol/L.

The halide ion is preferably a fluoride ion and/or a chloride ion. That is, the halide ion may be only a fluoride ion, only a chloride ion, or a mixture of fluoride and chloride ions. Any compound that can generate fluoride ions and/or chloride ions in a reaction solution can be used. Preferred examples of fluoride ion sources include ammonium hydrogen fluoride NH₄HF.HF and sodium fluoride NaF. Preferred examples of chloride ion sources include ammonium chloride NH₄Cl.

The concentration of the halide ions in the reaction solution varies depending on the thickness of the film to be produced that has an inorganic matrix and is composed of an inorganic composition and other factors and is usually in the range of 0.001 to 2 mol/kg and most preferably 0.002 to 0.3 mol/kg based on the total mass of the reaction solution containing a catalyst. A concentration of the halide ions of lower than 0.001 mol/kg cannot sufficiently complete the hydrolysis of the organometallic compound, resulting in a difficulty in formation of a film, whereas a concentration of the halide ions of higher than 2 mol/kg may readily generate a heterogeneous inorganic matrix (metal oxide glass). Such concentrations are therefore not preferred.

Regarding boron used in the reaction, when the designed composition of the resulting inorganic matrix contains boron in the form of a B₂O₃ component, the organic boron compound may be used in an amount calculated based on the content of the B₂O₃ component. When boron is required to be removed, boron in the form of a boron methyl ester is evaporated from the formed film by heating in the presence of methanol solvent or in a state immersed in methanol.

In the step of hydrolyzation and dehydrative condensation of an organometallic compound to prepare a reaction product, the reaction product is usually prepared as follows: A main ingredient solution is prepared by dissolving a predetermined amount of an organometallic compound in a predetermined amount of a mixture of water and an organic solvent; the main ingredient solution is mixed with a reaction solution containing a predetermined amount of halide ions at a predetermined ratio; the mixture is sufficiently stirred into a homogeneous reaction solution; the pH of the reaction solution is adjusted to a desired level with an acid or an alkali; and the reaction solution is aged for several hours to complete the hydrolyzation and dehydrative condensation. The boron compound is dissolved in the main ingredient solution or the reaction solution in advance. When an alkoxyborane is used, it is advantageous to dissolve the alkoxyborane together with other organometallic compounds in the main ingredient solution.

The pH of the reaction solution is determined depending on the purpose. In order to form a film composed of an inorganic composition having an inorganic matrix (metal oxide glass), the pH is preferably adjusted to a range of 4.5 to 5 with an acid such as hydrochloric acid for aging. In such a case, an indicator such as a mixture of methyl red and bromocresol green is conveniently used.

In the sol-gel method, the reaction product can be continuously produced by successively adding the main ingredient solution containing the same components at the same concentrations and the reaction solution (containing B³⁺ and halide ions) to the reaction system while the pH is being adjusted to a predetermined level. The concentration of the reaction solution can be varied within a range of ±50% by mass, the concentration of water (containing an acid or an alkali) can be varied within a range of ±30% by mass, and the concentration of the halide ions can be varied within a range of ±30% by mass.

Subsequently, the reaction product prepared in the preceding process (the reaction solution after aging) is heated and dried at a temperature of 200° C. or less for vitrification. During the heating, the temperature in the range of 50° C. to 70° C. is gradually raised with particular attention for predrying (solvent volatilization), and then the temperature is further raised. This drying step is important to form a nonporous film. After the step of predrying, the drying is preferably performed at a temperature of 70° C. to 150° C. and more preferably 80° C. to 130° C.

### 6-5. Polysilazane Method

The gas barrier layer may preferably contain an inorganic oxide that is formed by coating a ceramic precursor to form an inorganic oxide film by heat and then by locally heating the coated film.

For a ceramic precursor containing polysilazane, a glassy transparent coating film is preferably formed on a resin substrate through coating of the resin substrate with an organic solvent solution containing polysilazane represented by a general formula (8) below and optionally a catalyst, removal of the solvent by evaporation to form a polysilazane layer having a thickness of 0.05 to 3.0 μm on the resin substrate, and local heating of the polysilazane layer in an atmosphere containing water vapor in the presence of oxygen or active oxygen, and optionally nitrogen.

—(SiR¹R²—NR³)ₙ— (8)

In the formula (8), R¹, R², and R³ may be the same or different and each independently represent hydrogen, or optionally substituted alkyl, aryl, vinyl, or (trialkoxysilyl)alkyl and preferably hydrogen, or methyl, ethyl, propyl, isopropyl, butyl, isobutyl, tert-butyl, phenyl, vinyl, 3-(triethoxysilyl) propyl, or 3-(trimethoxysilylpropyl); and n represents an integer determined such that the polysilazane has a number-average molecular weight of 150 to 150,000 g/mol.

The catalyst is preferably a basic catalyst, specifically, N,N-diethylethanolamine, N,N-dimethylethanolamine, triethanolamine, triethylamine, 3-morpholinopropylamine, or N-heterocyclic compound. The concentration of the catalyst is usually in the range of 0.1% to 10% by mol and preferably 0.5% to 7% by mol on the basis of the amount of the polysilazane.

In a preferable embodiment, a solution containing perhydropolysilazane in which R¹, R², and R³ are all hydrogen atoms is used.

In another preferred embodiment, the coating according to the present invention contains at least one polysilazane represented by a general formula (9).

—(SiR¹R²—NR³)ₙ—(SiR⁴R⁵—NR⁶)ₚ— (9)

In the formula (9), R¹, R², R³, R⁴, R⁵, and R⁶ each independently represent hydrogen or optionally substituted alkyl, aryl, vinyl, or (trialkoxysilyl)alkyl; and n and p each represent an integer, and n is determined such that the polysilazane has a number-average molecular weight of 150 to 150,000 g/mol.

Particularly preferred polysilazanes are a compound in which R¹, R³, and R⁶ represent hydrogen and R², R⁴, and R⁵ represent methyl; a compound in which R¹, R³, and R⁶ represent hydrogen, R² and R⁴ represent methyl, and R⁵ represents vinyl; and a compound in which R¹, R³, R⁴, and R⁶ represent hydrogen and R² and R⁵ represent methyl.

A solution containing at least one polysilazane represented by a general formula (10) below is also preferred.

—(SiR¹R²—NR³)ₙ—(SiR⁴R⁵—NR⁶)ₚ—(SiR⁷R⁸—NR⁹)_{q}— (10)

In the formula (10), R¹, R², R³, R⁴, R⁵, R⁶, R⁷, R⁸, and R⁹ each independently represent hydrogen or optionally substituted alkyl, aryl, vinyl, or (trialkoxysilyl)alkyl; and n, p, and q each represent an integer, and n is determined such that the polysilazane has a number-average molecular weight of 150 to 150,000 g/mol.

Particularly preferred polysilazanes are compounds in which R¹, R³, and R⁶ represent hydrogen, and R², R⁴, R⁵, and R⁸ represent methyl, R⁹ represents (triethoxysilyl)propyl, and R⁷ represents alkyl or hydrogen.

The content of the polysilazane in a solvent is usually 1% to 80% by mass, preferably 5% to 50% by mass, and most preferably 10% to 40% by mass.

The solvent is an organic, preferably, aprotic solvent, in particular, not containing water and reactive groups (e.g., hydroxyl group and amino group) and being inactive to polysilazane. Examples of such solvents include aliphatic or aromatic hydrocarbons, halogenated hydrocarbons, esters such as ethyl acetate and butyl acetate, ketones such as acetone and methyl ethyl ketone, ethers such as tetrahydrofuran and dibutyl ether, mono- and polyalkylene glycol dialkyl ethers (diglymes), and mixtures of these solvents.

Binders that are commonly used for production of paint may be added to the polysilazane solution. Examples of such binders include cellulose ethers and cellulose esters such as ethylcellulose, nitrocellulose, cellulose acetate, and cellulose acetobutyrate; natural resins such as rubber and rosin resins; synthetic resins such as polymer resins; condensate resins such as aminoplast, in particular, urea resins, melamine formaldehyde resins, alkyd resins, acrylic resins, polyesters, modified polyesters, epoxides, polyisocyanates, blocked polyisocyanates, and polysiloxanes.

Other components in the polysilazane composition are, for example, additives that affect the viscosity of the composition, wettability of a base, film-forming properties, lubricating action, or evacuating properties; or inorganic nanoparticles composed of, for example, SiO₂, TiO₂, ZnO, ZrO₂, or Al₂O₃.

The methods described above do not cause occurrence of cracks and pores and can therefore produce dense glassy layers acting as an excellent gas barrier.

The resulting gas barrier layer preferably has a thickness within a range of 100 nm to 2 μm.

### 7. Anchoring Layer

The anchoring layer is composed of a resin and serves as a layer provided for achieving tight adhesion between the resin substrate and the silver layer. Accordingly, the anchoring layer preferably has adhesiveness for achieving tight adhesion between the resin substrate and the silver layer, heat resistance for tolerating the heat during the formation of the silver layer by, for example, vacuum deposition, and smoothness for bringing out the inherent high reflectivity of the silver layer.

The resin used in the anchoring layer may be any resin that satisfies the required adhesion, heat resistance, and smoothness. For example, polyester resins, acrylic resins, melamine resins, epoxy resins, polyamide resins, vinyl chloride resins, and vinyl chloride/vinyl acetate copolymer resins can be used alone or in combination. From the viewpoint of weather resistance, preferred are resin mixtures of polyester resins and melamine resins and resin mixtures of polyester resins and acrylic resins; and more preferred are thermosetting resins containing curing agents such as isocyanate.

The anchoring layer preferably has a thickness of 0.01 to 3 μm and more preferably 0.1 to 2 μm. In this range, the anchoring layer can cover the surface unevenness of the resin substrate to give sufficient smoothness while maintaining the adhesion and can sufficiently harden.

The anchoring layer can preferably contain any corrosion inhibitor, which is described in “5. Corrosion Inhibitor” above.

The anchoring layer can be formed by a known coating process such as gravure coating, reverse coating, or die coating.

### 8. Tacky Layer

The functional film preferably includes a tacky layer opposite side of the outermost layer so that the functional film is attached to another member. The functional film is attached to another member through the tacky layer. The functional film may include a release layer on the opposite side of the tacky layer from the outermost layer. In the case where the functional film has a release layer, the functional film can be attached to a support base material through the tacky layer after the release layer of the functional film is peeled off.

The tacky layer may be composed of any material such as a dry laminating agent, a wet laminating agent, an adhesive, heat sealing agent, or a hot melting agent. Examples of the adhesive include polyester resins, urethane resins, polyvinyl acetate resins, acrylic resins, and nitrile rubber. Any lamination process can be employed. For example, continuous roll lamination is preferred from the viewpoints of economy and productivity. The tacky layer preferably has a thickness in the range of about 1 to 100 μm from the viewpoints of, for example, adhesive effect and drying rate.

### EXAMPLES

The present invention will now be specifically described by examples, which should not be intended to limit the invention. In examples, a heat barrier film will be described as an exemplary functional film.

(Production of Heat Barrier Film)

(Production of Heat Barrier Film 1)

A biaxially stretched polyester film (polyethylene terephthalate film, thickness: 100 μm) was used as a resin substrate. One surface of the polyethylene terephthalate film was coated with a solution (a solid content: 10%) of a resin mixture in toluene by gravure coating to form an anchoring layer having a thickness of 0.1 μm. The mixture was composed of a polyester resin (Polyester SP-181, manufactured by The Nippon Synthetic Chemical Industry Co., Ltd.), a melamine resin (Super Beckamine J-820, manufactured by DIC Corporation), 2,4-tolylene diisocyanate (TDI), and 1,6-hexamethylene diisocyanate (HDMI) at a content ratio of 20:1:1:2 on the basis of the solid content. On the anchoring layer, a silver layer having a thickness of 10 nm was formed by vacuum deposition. On the silver layer, an upper adjoining layer having a thickness of 0.1 μm was formed by gravure coating of a 10:2 mixture on the basis of the solid content of a polyester-based resin and a tolylene diisocyanate (TDI). Heat barrier film 1 of Comparative Example was thus prepared.

(Production of Heat Barrier Film 2)

Heat barrier film 2 of Comparative Example was produced as in heat barrier film 1 except that an outermost layer was disposed on the polyester film at the opposite side of the silver layer.

(Outermost Layer)

A coating solution for the outermost layer having the following composition was prepared and was applied onto the polyester film with a microgravure coater such that the thickness after curing became 3 μm. The solvent was evaporated, followed by curing by irradiation with ultraviolet rays of 0.2 J/cm² using a high-pressure mercury lamp. The outermost layer was thus formed.

### (Coating Solution for Outermost Layer)

Dipentaerythritol hexaacrylate: 70 parts by mass

Trimethylolpropane triacrylate: 30 parts by mass

Photoreaction initiator (Irgacure 184 (manufactured by Ciba Japan K.K.)): 4 parts by mass

Ethyl acetate: 150 parts by mass

Propylene glycol monomethyl ether: 150 parts by mass

Silicon compound (BYK-307 (manufactured by BYK-Chemie Japan K.K.)): 0.4 parts by mass

(Production of Heat Barrier Film 3)

Heat barrier film 3 of Comparative Example was produced by the same way as that of the heat barrier film 1 except that a chamber was evacuated to an ultimate vacuum of 3.0×10⁻⁵ torr (4.0×10⁻³ Pa) in a vacuum evaporation system, oxygen gas was introduced to the vicinity of a coating drum while the pressure in the chamber was maintained at 3.0×10⁻⁴ torr (4.0×10⁻² Pa), and silicon monoxide was deposited by heating a vapor source with a Pierce electron gun at an electric power of about 1.0 kw to form a silicon oxide layer having a thickness of 1 μm on the polyester film, at an opposite side of the silver layer, which traveled at a rate of 120 m/min on the coating drum.

(Production of Heat Barrier Film 4)

A biaxially stretched polyester film (polyethylene terephthalate film, thickness: 100 μm) was used as a resin substrate. One surface of the polyethylene terephthalate film was coated with a 20:1:1:2 mixture on the basis of solid content of the polyester resin, the melamine resin, tolylene diisocyanate (TDI), and HDMI by gravure coating to form an anchoring layer having a thickness of 0.1 μm. On the anchoring layer, a silver layer having a thickness of 10 nm was formed by vacuum deposition. On the silver layer, an upper adjoining layer having a thickness of 0.1 μm was formed by gravure coating using a 10:2 mixture on the basis of the solid content of a polyester resin and TDI. An outermost layer was formed on the polyester film at an opposite side of the silver layer by a bar-coating using a 3% perhydropolysilazane solution (NL120, manufactured by AZ Electronic Materials plc) in dibutyl ether such that the dried thickness became 500 nm, spontaneously evaporating the solvent for 3 minutes, and then annealing the coating in an oven at 90° C. for 30 minutes. The heat barrier film 4 of Comparative Example was thus prepared.

(Production of Heat Barrier Film 5)

Heat barrier film 5 of Comparative Example was produced by the same way as that of the heat barrier film 4 except that organic polysilazane (MHPS-20 DB) was used instead of the perhydropolysilazane solution.

(Production of Heat Barrier Film 6)

A biaxially stretched polyester film (polyethylene terephthalate film, thickness: 100 μm) was used as a resin substrate. On one surface of the polyethylene terephthalate film, an anchoring layer having a thickness of 0.1 μm was formed by gravure coating using a 20:1:1:2 mixture on the basis of the solid content of the polyester resin, the melamine resin, tolylene diisocyanate (TDI), and HMDI. On a tacky layer, a silver layer having a thickness of 10 nm was formed by vacuum deposition. On the silver layer, an upper adjoining layer having a thickness of 0.1 μm was formed by gravure coating using a 10:2 mixture on the basis of the solid content of a polyester-based resin and TDI. On the upper adjoining layer, an outermost layer was formed by bar-coating using a 3% perhydropolysilazane solution (NL120, manufactured by AZ Electronic Materials plc) in dibutyl ether containing 8 parts by mass of STR-60 (titanium oxide, manufactured by Sakai Chemical Industry Co., Ltd.) such that the dried thickness became 500 nm, spontaneously evaporating the solvent for 3 minutes, and then annealing the coating in an oven at 90° C. for 30 minutes. Furthermore, a thin film was formed on the surface of the outermost layer by bar-coating using a water-repellent agent (Aquanolan, manufactured by AZ Electronic Materials plc). The heat barrier film 6 of the present invention was thus prepared.

(Production of Heat Barrier Film 7)

Heat barrier film 7 of the present invention was produced in the same way as that of the heat barrier film 6 except that the outermost layer was formed from an organic polysilazane (MHPS-20 DB).

(Production of Heat Barrier Film 8)

Heat barrier film 8 of the present invention was produced in the same way as that of the heat barrier film 6 except that the outermost layer was formed by a sol-gel method below.

(Formation of Outermost Layer by Sol-gel Method: Formation of Silica Layer)

A sol solution of an organometallic compound as a raw material was prepared as follows: 0.04 mol of tetraethoxysilane (manufactured by Wako Pure Chemical Industries, Ltd.) was weighed in a polypropylene beaker, and 0.25 mol of ethanol was added thereto with stirring, followed by stirring with a magnetic stirrer for 10 minutes. Furthermore, 0.24 mol of pure water was added to the mixture, followed by stirring for 10 minutes. To the mixture, 1 mL of 1 mol/L HCl and then 8 parts by mass of STR-60 (titanium oxide manufactured by Sakai Chemical Industry Co., Ltd.) were added to give sol solution 1.

The sol solution 1 was bar-coated on the silver layer of the polyester film of heat barrier film 6 such that the dried thickness became 500 nm, followed by drying in a dry oven at 80° C. for 30 minutes and irradiation with infrared rays for 0.5 seconds at an output of 1 kw ten times at a distance of 50 cm from the coated surface using a near-infrared dryer (paint dryer PDH1000 manufactured by Nihon Dennetsu Co., Ltd.) to form an outermost layer on the polyester substrate. The heat barrier film 8 was thus produced.

(Production of Heat Barrier Film 9)

Heat barrier film 9 of the present invention was produced in the same way as that of the heat barrier film 6 except that the outermost layer was formed by a sol-gel method below.

(Formation of Outermost Layer by Sol-Gel Method: Formation of Alumina Layer)

A sol solution of an organometallic compound as a raw material was prepared as follows: 0.04 mol of aluminum isopropoxide (manufactured by Wako Pure Chemical Industries, Ltd.) was weighed in a polypropylene beaker, and 0.25 mol of isopropyl alcohol was added thereto with stirring, followed by stirring with a magnetic stirrer for 10 minutes. Furthermore, 0.24 mol of pure water was added to the mixture, followed by stirring for 10 minutes. To the mixture, 1 mL of 1 mol/L HCl and then 8 parts by mass of STR-60 (titanium oxide, manufactured by Sakai Chemical Industry Co., Ltd.) were added to give a sol solution 2.

The sol solution 2 was bar-coated on the silver layer of the polyester film of heat barrier film 6 such that the dried thickness became 500 nm, followed by drying in a dry oven at 80° C. for 30 minutes and irradiation with infrared rays for 0.5 seconds at an output of 1 kw ten times at a distance of 50 cm from the coated surface using a near-infrared dryer (paint dryer PDH1000 manufactured by Nihon Dennetsu Co., Ltd.). The heat barrier film 9 was thus produced.

(Production of Heat Barrier Film 10)

Heat barrier film 10 was produced in the same way as that of the heat barrier film 6 except that Beautiful G'ZOX Real Glass Coat manufactured by Soft99 Corporation was used as the water-repellent agent.

(Production of Heat Barrier Film 11)

Heat barrier film 11 was produced in the same way as that of the heat barrier film 10 except that a gas barrier layer composed of silicon oxide was formed between the polyester film and the anchoring layer by vacuum deposition described below prior to the application of the anchoring layer to the polyester film.

(Formation of Gas Barrier Layer by Vacuum Deposition)

A chamber was evacuated to an ultimate vacuum of 3.0×10⁻⁵ torr (4.0×10⁻³ Pa) in a vacuum evaporation system, oxygen gas was introduced to the vicinity of a coating drum while the pressure in the chamber was maintained at 3.0×10⁻⁴ torr (4.0×10⁻² Pa), and silicon monoxide was deposited by heating a vapor source with a Pierce electron gun at an electric power of about 10 kw to form a gas barrier layer having a thickness of 100 nm composed of silicon oxide on the polyester film running at a rate of 120 m/min on the coating drum.

(Production of Heat Barrier Film 12)

Heat barrier film 12 of the present invention was produced in the same way as that of the heat barrier film 11 except that a polyester film containing an ultraviolet absorber, TINUVIN 928, in an amount of 1% by mass based on the amount of the polyester resin was used as the resin substrate.

(Production of Heat Barrier Film 13)

Heat barrier film 13 of the present invention was produced in the same way as that of the heat barrier film 12 except that a corrosion inhibitor, glycol dimercaptoacetate, was added in each of the anchoring layer and the upper adjoining layer such that a density of the corrosion inhibitor became 0.2 g/m² after application.

(Evaluation of Heat Barrier Films 1 to 13)

The contact angle with water and the coefficient of dynamical friction of the surface of the outermost layer, at an opposite side of the silver layer, of each polyester film of the heat barrier films 1 to 13 produced above were measured.

The structures of heat barrier films 1 to 13 and the contact angles with water and coefficients of dynamical friction of the outermost layers are shown in Table 1.

TABLE 1

| | | | COEFFICIENT | | ULTRAVIOLET | | |
|---|---|---|---|---|---|---|---|
| HEAT | | | OF | GAS | ABSORBER IN | | |
| BARRIER | OUTERMOST | CONTACT | DYNAMICAL | BARRIER | OUTERMOST | CORROSION | |
| FILM | LAYER | ANGLE | FRICTION | LAYER | LAYER | INHIBITOR | REMARKS |
| 1 | POLYESTER RESIN | 75° | 0.39 | — | — | — | COMPARATIVE EXAMPLE |
| 2 | ACRYLIC RESIN | 72° | 0.37 | — | — | — | COMPARATIVE EXAMPLE |
| 3 | SILICON OXIDE | 40° | 0.36 | — | — | — | COMPARATIVE EXAMPLE |
| 4 | SILICON OXIDE | 30° | 0.35 | — | — | — | COMPARATIVE EXAMPLE |
| 5 | SILICON OXIDE | 85° | 0.38 | — | — | — | COMPARATIVE EXAMPLE |
| 6 | SILICON OXIDE | 100° | 0.28 | — | CONTAINED | — | EXAMPLE |
| 7 | SILICON OXIDE | 110° | 0.25 | — | CONTAINED | — | EXAMPLE |
| 8 | SILICON OXIDE | 98° | 0.27 | — | CONTAINED | — | EXAMPLE |
| 9 | ALUMINUM OXIDE | 91° | 0.31 | — | CONTAINED | — | EXAMPLE |
| 10 | SILICON OXIDE | 130° | 0.23 | — | CONTAINED | — | EXAMPLE |
| 11 | SILICON OXIDE | 130° | 0.23 | PROVIDED | CONTAINED | — | EXAMPLE |
| 12 | SILICON OXIDE | 130° | 0.23 | PROVIDED | CONTAINED | — | EXAMPLE |
| 13 | SILICON OXIDE | 130° | 0.23 | PROVIDED | CONTAINED | CONTAINED | EXAMPLE |

(Evaluation of Heat Barrier Film)

The heat barrier films were evaluated for the weather resistance, light resistance, and pencil hardness and subjected to a steel wool test and a yellowing test by the following methods.

(Weather Resistance Test of Thermal Insulation)

The thermal insulation capability of each heat barrier film left to stand at 85° C. and 85% RH for 30 days was measured. The falling rate of the thermal insulation capability was calculated from the thermal insulation capabilities before and after the enforced degradation and was evaluated by the following criteria. The thermal insulation capability was measured by reflectivity for infrared rays.

5: falling rate of thermal insulation capability<5%,

4: 5%≦falling rate of thermal insulation capability<10%,

3: 10%≦falling rate of thermal insulation capability<15%,

2: 15%≦falling rate of thermal insulation capability<20%, and

1: 20%≦falling rate of thermal insulation capability.

(Light Resistance Test of Thermal Insulation Capability)

The thermal, insulation capability of each heat barrier film, irradiated with ultraviolet rays with an Eye Super UV tester manufactured by Iwasaki Electric Co., Ltd. at 65° C. for 7 days, was measured by the method described above. The falling rate of thermal insulation capability after the ultraviolet ray irradiation was calculated and was evaluated by the following criteria.

5: falling rate of thermal insulation capability<5%,

4: 5%≦falling rate of thermal insulation capability<10%,

3: 10%≦falling rate of thermal insulation capability<15%,

2: 15%≦falling rate of thermal insulation capability<20%, and

1: 20%≦falling rate of thermal insulation capability.

(Pencil Hardness Test)

The pencil hardness of each sample was measured at a tilt of 45° and a load of 1 kg in accordance with JIS-K5400.

(Steel Wool Test)

The surface of each heat barrier film was sprayed with 10 mL of pure water with an atomizer and was then rubbed with steel wool #0000 by ten cycles of reciprocating motions under a friction load of 1000 g/cm². The surface was visually observed for scratches and was evaluated by the following criteria.

5: no scratches were observed,

4: few scratches were observed,

3: practically acceptable scratches were observed,

2: impractical levels of scratches were observed, and

1: significant scratches were observed.

(Yellowing)

Each heat barrier film was irradiated with ultraviolet rays with an Eye Super UV tester manufactured by Iwasaki Electric Co., Ltd. at 65° C. for 7 days and was then visually observed for yellowing and evaluated by the following criteria.

5: no visual difference in color,

4: slight visual difference in color,

3: practically acceptable level of visual difference in color,

2: impractical level of distinct visual difference in color, and

1: significant visual difference in color.

Table 2 shows the results of the evaluation.

TABLE 2

| HEAT | | | | | | |
|---|---|---|---|---|---|---|
| BARRIER | WEATHER | LIGHT | PENCIL | | | |
| FILM | RESISTANCE | RESISTANCE | HARDNESS | STEEL WOOL TEST | YELLOWING | REMARKS |
| 1 | 1 | 2 | 4B | 1 | 2 | COMPARATIVE EXAMPLE |
| 2 | 1 | 1 | 2H | 3 | 1 | COMPARATIVE EXAMPLE |
| 3 | 2 | 3 | 3H | 3 | 3 | COMPARATIVE EXAMPLE |
| 4 | 3 | 3 | 3H | 3 | 3 | COMPARATIVE EXAMPLE |
| 5 | 3 | 2 | 2H | 3 | 2 | COMPARATIVE EXAMPLE |
| 6 | 4 | 5 | 5H | 4 | 5 | EXAMPLE |
| 7 | 4 | 5 | 4H | 4 | 5 | EXAMPLE |
| 8 | 4 | 5 | 3H | 4 | 5 | EXAMPLE |
| 9 | 3 | 5 | 3H | 4 | 5 | EXAMPLE |
| 10 | 4 | 5 | 5H | 5 | 5 | EXAMPLE |
| 11 | 5 | 5 | 5H | 5 | 5 | EXAMPLE |
| 12 | 5 | 5 | 5H | 5 | 5 | EXAMPLE |
| 13 | 5 | 5 | 5H | 5 | 5 | EXAMPLE |

Table 2 demonstrates that the heat barrier films of the present invention are excellent in various characteristics compared to the heat barrier films of Comparative Examples. That is, the means of the present invention described above can provide heat barrier films having high scratch and weather resistances.

As described above, the functional film according to the present invention has high scratch, weather, and fouling resistances. The functional film can be produced at high productivity by, for example, a roll-to-roll system.

### INDUSTRIAL APPLICABILITY

The present invention is structured as described above and can be utilized as a functional film.

What is claimed is:

1. A functional film comprising a resin substrate, the film comprising:
an outermost layer comprising a material having a metalloxane skeleton,
wherein the outermost layer contains an ultraviolet absorber, and
a surface of the functional film has a contact angle with water of 80° or more and less than 170° and a coefficient of dynamical friction of 0.10 or more and 0.35 or less.

2. The functional film according to claim 1, wherein the outermost layer has a pencil hardness of H or more and 7H or less.

3. The functional film according to claim 1, wherein the coefficient of dynamical friction is 0.15 or more and 0.30 or less.

4. The functional film according to claim 1, wherein the surface of the functional film has a surface resistivity of 1×10¹³Ω/□ or less.

5. The functional film according to any claim 1, wherein the outermost layer is formed through a thermal curing reaction using a sol-gel method.

6. The functional film according to claim 1, wherein the material having a metalloxane skeleton is polysiloxane.

7. The functional film according to claim 1, further comprising an antistatic layer between the outermost layer and the resin substrate.

8. The functional film according to claim 1, wherein the ultraviolet absorber is an inorganic ultraviolet absorber.

9. The functional film according to claim 1, further comprising a silver layer having a thickness of 0.1 nm or more and 50 nm or less.

10. The functional film according to claim 9, wherein the functional film is a heat barrier film.

11. The functional film according to claim 9, wherein a layer adjoining the silver layer contains a silver corrosion inhibitor.

12. The functional film according to claim 3, wherein the surface of the functional film has a surface resistivity of 3.0×10⁹Ω/□ or more and 2.0×10¹¹Ω/□ or less.

13. The functional film according to claim 1, wherein the surface of the functional film has a contact angle with water of 90° or more and 150° or less.

14. A functional film comprising:
an outermost layer comprising an ultraviolet absorber and a material having a metalloxane skeleton,
wherein a surface of the functional film has a contact angle with water of 90° or more and 150° or less and a coefficient of dynamical friction of 0.15 or more and 0.30 or less.

15. The functional film according to claim 14, wherein the outermost layer has a pencil hardness of H or more and 7H or less.

16. The functional film according to claim 14, wherein the surface of the functional film has a surface resistivity of 1.0×10⁻³Ω/□ or more and 1.0×10¹²Ω/□ or less.

17. The functional film according to claim 14, further comprising an antistatic layer.

18. The functional film according to claim 17, wherein the antistatic layer is provided adjoining the outermost layer.
